(19) United States
(12) Patent Application Publication
(10) Pub. No.: US 2026/0019528 A1
(43) Pub. Date: Jan. 15, 2026

(54) IMAGE READING DEVICE, IMAGE INSPECTION SYSTEM, AND RECORDING MEDIUM

(71) Applicant: Konica Minolta, Inc., Tokyo (JP)

(72) Inventor: Masao Nakamura, Tokyo (JP)

(73) Assignee: Konica Minolta, Inc., Tokyo (JP)

(21) Appl. No.: 19/262,577

(22) Filed: Jul. 8, 2025

(30) Foreign Application Priority Data
Jul. 9, 2024 (JP) 2024-110208

(51) Int. Cl. H04N 1/60; G03G 15/23; G06T 7/00

(52) U.S. Cl. CPC H04N 1/6094; G06T 7/0004; H04N 1/603; G03G 15/234; G06T 2207/30144; G06T 2207/30168

(57) ABSTRACT

An image reading device includes: an image reader that is disposed downstream of an image forming apparatus and reads a printed material that is a sheet on which an image has been formed by the image forming apparatus; and a hardware processor that controls the reading by the image reader. The hardware processor: performs shading correction on the image reader when the image reading device is activated or before printing is started by the image forming apparatus, based on shading data acquired by causing the image reader to read a white reference plate disposed opposite the image reader; extracts image data of an unprinted region of the printed material during the reading by the image reader, based on scan data of the printed material read by the image reader; and creates sheet color data for the image reader based on the image data that has been extracted.

### BACKGROUND OF THE INVENTION

### Technical Field

The present invention relates to an image reading device, an image inspection system, and a recording medium.

### Description of Related Art

A printed material printed by an image forming apparatus becomes defective when color misalignment or distortion occurs. An image inspection apparatus detects a defect (image defect) on a printed material and inspects the quality of the printed material based on the detected image defect. The image inspection apparatus detects an image defect on the printed material based on a difference between a reference image (correct image) and an image read by an image reading section.

For example, JP 2020-204720A and JP 2021-190928A each discloses a configuration for comparing a correct image with a read image to inspect a printed material.

### SUMMARY OF THE INVENTION

A problem with an image reading section used for image inspection is that an efficiency of a light emitting element and a controller changes due to heat generated by continuous lighting of a light source, causing an illuminance (light amount) to change over time. In recent years, an LED light source has replaced a halogen light source in an image reading section, reducing a light amount change during an initial lighting period and a light amount change due to temperature rise over time. However, when the LED light source is turned on continuously for 10 minutes, 30 minutes, and one hour, an efficiency of an LED element and a drive circuit changes due to a temperature change over time, and thus the light amount change never becomes zero. Scan data obtained by reading a printed material by an image reading section has different read values (color tone) between the first sheet and the Nth sheet when the light amount of the light source changes. This affects inspection and colorimetry by an image inspection apparatus. When the color tone of the scan data of a colorimetric patch differs, the image inspection apparatus instructs the image forming apparatus to perform an incorrect color correction. One method for reducing the influence of the light amount change of the light source is to ensure a sufficient lighting time before a start of printing. However, the method to ensure the sufficient lighting time before the start of printing has a problem in that downtime occurs and even then, the light amount changes over a long period of operation.

In order to cope with the light amount change of the light source, it is necessary to perform shading correction during continuous printing. In order to perform the shading correction during continuous printing, it is necessary to stop printing once and cause the image reading section to read a white reference plate. Therefore, there is a problem of downtime.

It is an object of the present invention to provide an image reading device, an image inspection system, and a recording medium that can improve an accuracy of inspection and colorimetry by an image inspection apparatus without causing downtime.

To achieve at least one of the abovementioned objects, an image reading device reflecting one aspect of the present invention comprises: an image reader that is disposed downstream of an image forming apparatus and performs reading of a printed material, the printed material being a sheet on which an image has been formed by the image forming apparatus; and a hardware processor that controls the reading performed by the image reader, wherein the hardware processor: performs shading correction on the image reader at a time of activation of the image reading device or before printing is started by the image forming apparatus, based on shading data acquired by causing the image reader to read a white reference plate disposed opposite the image reader; extracts image data of an unprinted region of the printed material during the reading of the printed material performed by the image reader, based on scan data of the printed material read by the image reader; and creates sheet color data for the image reader based on the image data of the unprinted region that has been extracted.

To achieve at least one of the abovementioned objects, an image inspection system reflecting another aspect of the present invention comprises: an image reader that is disposed downstream of an image forming apparatus and performs reading of a printed material, the printed material being a sheet on which an image has been formed by the image forming apparatus; and a hardware processor that controls the reading performed by the image reader, inspects the image based on scan data of the printed material read by the image reader, and instructs the image forming apparatus to perform color correction based on the scan data, wherein the hardware processor: performs shading correction on the image reader at a time of activation of the image inspection system or before printing is started by the image forming apparatus, based on shading data acquired by causing the image reader to read a white reference plate disposed opposite the image reader; extracts image data of an unprinted region of the printed material during the reading of the printed material performed by the image reader, based on the scan data; and creates sheet color data for the image reader based on the image data of the unprinted region that has been extracted.

To achieve at least one of the abovementioned objects, a recording medium reflecting yet another aspect of the present invention is a non-transitory computer-readable recording medium storing a program executable by a computer, the program causing a computer of an image reading device including an image reader that is disposed downstream of an image forming apparatus and performs reading of a printed material, the printed material being a sheet on which an image has been formed by the image forming apparatus, to execute: controlling the reading performed by the image reader; performing shading correction on the image reader at a time of activation of the image reading device or before printing is started by the image forming apparatus, based on shading data acquired by causing the image reader to read a white reference plate disposed opposite the image reader; extracting image data of an unprinted region of the printed material during the reading of the printed material performed by the image reader, based on scan data of the printed material read by the image reader; and creating sheet color data for the image reader based on the image data of the unprinted region that has been extracted.

### BRIEF DESCRIPTION OF THE DRAWINGS

The advantages and features provided by one or more embodiments of the invention will become more fully understood from the detailed description given hereinafter and the appended drawings which are given by way of illustration only, and thus are not intended as a definition of the limits of the present invention, and wherein:

FIG. 1 is a diagram illustrating a schematic configuration of an image inspection system according to the present embodiment;

FIG. 2 is a functional block diagram illustrating a control structure of the image inspection system according to the present embodiment;

FIG. 3 is a flowchart illustrating control before printing is started;

FIG. 4 is a diagram illustrating a method for simply identifying and extracting an unprinted region from a correct image;

FIG. 5 is an enlarged view of a vicinity of a character “A” printed in a simple text region;

FIG. 6 is a flowchart illustrating control during a printing operation for a first page;

FIG. 7 is a flowchart illustrating control (1) during a printing operation for a second page;

FIG. 8 is a diagram illustrating sheet color data of the first page and a Nth page;

FIG. 9 is a diagram illustrating how a difference in sheet color data is reflected in each piece of data in a reading controller; and

FIG. 10 is a flowchart illustrating control (2) during the printing operation for the second page.

### DETAILED DESCRIPTION

Hereinafter, one or more embodiments of the present invention will be described with reference to the drawings. However, the scope of the invention is not limited to the disclosed embodiments.

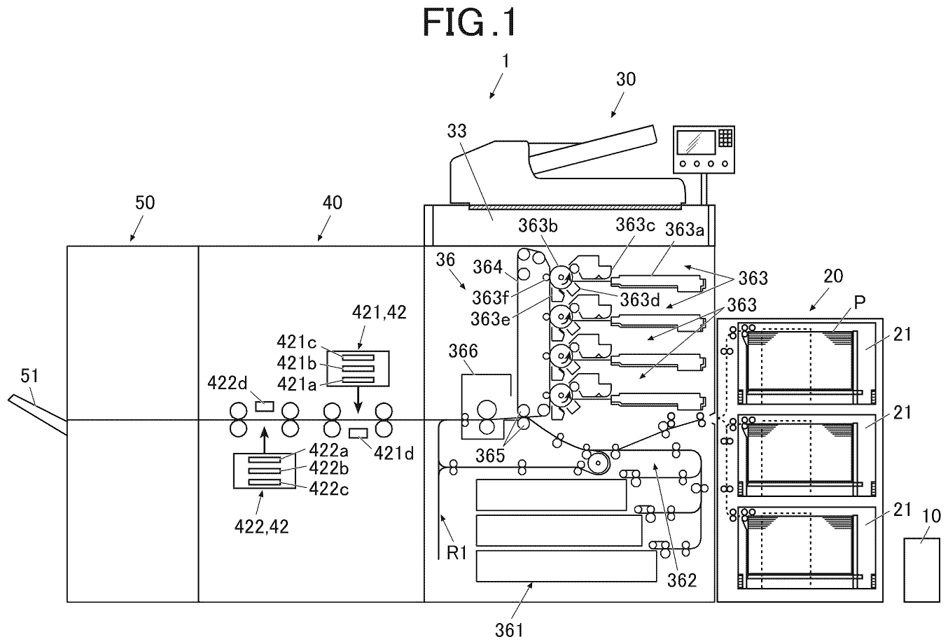

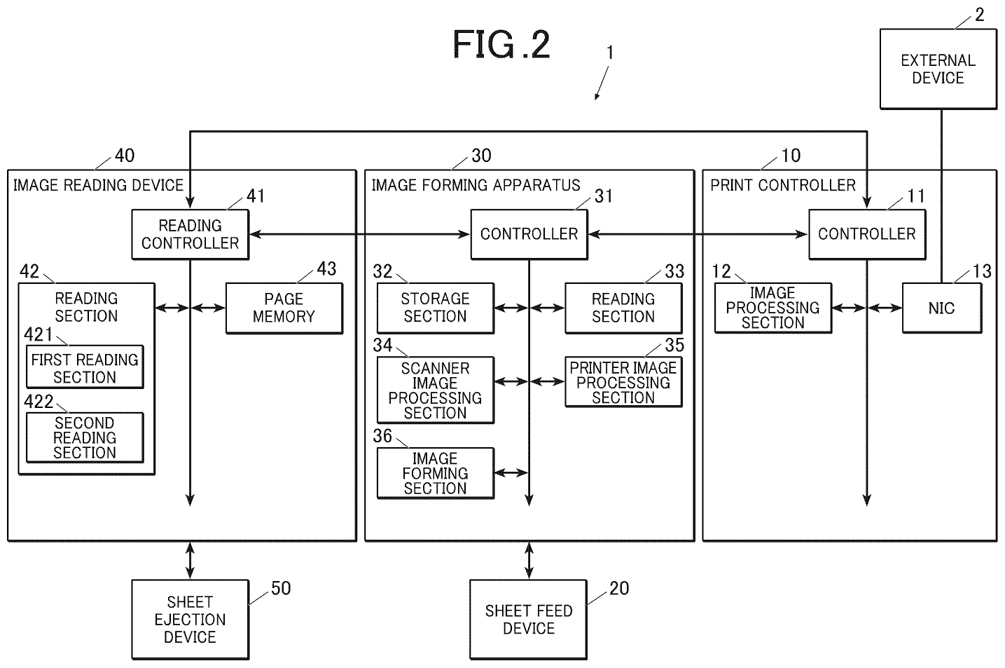

As illustrated in FIGS. 1 and 2, an image inspection system 1 according to the present embodiment includes a print controller 10, a sheet feed device 20, an image forming apparatus 30, an image reading device 40, and a sheet ejection device 50. The image inspection system 1 is connected to an external device 2 such as a personal computer (PC) via an NIC 13 of the print controller 10 so as to be able to transmit and receive information to and from the external device 2.

When the image forming apparatus 30 is used as a network printer, the print controller 10 manages and controls image data. The image data is input to the image forming apparatus 30 from the external device 2 connected to a LAN. The print controller 10 receives image data to be printed from the external device 2 and transmits the received image data to the image forming apparatus 30.

The print controller 10 includes a controller (hardware processor) 11, an image processing section 12, and the NIC 13.

The controller 11 includes a CPU, a ROM, and a RAM and comprehensively controls an operation of each component of the print controller 10. The controller 11 outputs the image data input from the external device 2 to the image forming apparatus 30 via the NIC 13.

The image processing section 12 may be implemented as a function of the controller 11 and performs rasterization (RIP) processing on the image data input from the external device 2 to generate image data (RIP image data) of each color of CMYK.

The NIC 13 is a communication interface that receives the image data to be printed from the external device 2 via the LAN.

The sheet feed device 20 includes a plurality of sheet feed trays 21 and a sheet feed means (not illustrated) and feeds a sheet P stored in one of the sheet feed trays 21 to the image forming apparatus 30. The sheet feed means includes, for example, a sheet feed roller, a separation roller, a sheet feed/separation rubber, a feed-out roller and the like. Each of the sheet feed trays 21 stores a sheet P for each type of the sheet P (sheet type, basis weight, sheet size, and the like). The sheet feed device 20 conveys sheets P one by one from the top of the sheets P stored in each sheet feed tray 21 to the image forming apparatus 30.

The image forming apparatus 30 is a multifunction apparatus that forms an image on a sheet based on image data read from a document and/or image data received from the external device 2 via the LAN. The image forming apparatus 30 includes a controller (hardware processor) 31, a storage section (or storage) 32, a reading section (or image reader) 33, a scanner image processing section 34, a printer image processing section 35, and an image forming section (or image forming device) 36.

The controller 31 includes a CPU, a RAM, a ROM, and the like. First, the CPU reads various processing programs stored in the ROM and develops the programs in the RAM. Next, the CPU comprehensively controls the operation of each component of the image forming apparatus 30 in cooperation with the various programs developed in the RAM.

The storage section 32 stores programs readable by the controller 31, files for executing the programs, and the like. The storage section 32 includes, for example, a large-capacity memory such as a hard disk.

The reading section 33 includes an automatic document feeder, a scanner and the like and reads a document surface set on a document plate to generate bitmap image data. The image data generated by the reading section 33 is color-converted into image data in which each pixel has pixel values of three colors of R (red), G (green), and B (blue) and has pixel values of four colors of C, M, Y, and K.

The scanner image processing section 34 may be implemented as a function of the controller 31 and performs various kinds of processing on analog image data input from the reading section 33 and then generates digital image data. The various kinds of processing include analog processing, A/D conversion processing, shading processing, and the like. The generated image data is output to the printer image processing section 35.

The printer image processing section 35 may be implemented as a function of the controller 31 and generates print image data based on the image data input from the scanner image processing section 34 or the image processing section 12 of the print controller 10. The print image data is image data for image formation. The print image data generated by the printer image processing section 35 is output to the image forming section 36.

The image forming section 36 performs image formation processing using an electrophotographic method. The image forming section 36 forms an image of four colors of C, M, Y, and K on a sheet in accordance with the pixel values of the four colors at each pixel of the print image data.

The image forming section 36 includes a sheet feed section 361, a conveyance section 362, four writing units 363, an intermediate transfer belt 364, a transfer section 365, and a fixing section 366.

The sheet feed section 361 includes a plurality of sheet feed trays and a sheet feed means (not illustrated). The sheet feed means includes, for example, a sheet feed roller, a separation roller, a sheet feed/separation rubber, a feed-out roller and the like. Each of the sheet feed trays stores a sheet P for each type of the sheet P (sheet type, basis weight, sheet size, and the like). The sheet feed section 361 conveys sheets P one by one from the top of the sheets P stored in each sheet feed tray to the conveyance section 362.

The conveyance section 362 conveys the sheet conveyed from the sheet feed section 361 to a secondary transfer position of the image forming section 36 via a sheet conveyance route to the transfer section 365.

The four writing units 363 are disposed in series (tandem) along a belt surface of the intermediate transfer belt 364 to form images of respective C, M, Y and K colors. The writing units 363 have the same configuration except that they form images of different colors. Each of the writing units 363 includes an exposure section 363a, a photosensitive drum 363b, a developing section 363c, a charging section 363d, a cleaning section 363e, and a primary transfer roller 363f.

In image formation, first, each of the writing units 363 causes the charging section 363d to charge the photosensitive drum 363b. Next, the writing unit 363 scans the photosensitive drums 363b with a light flux emitted from the exposure sections 363a based on the image data, thereby forming an electrostatic latent image. Next, the writing unit 363 causes the developing section 363c to supply toner to develop the image. Thus, an image (monochromatic toner image) is formed on the photosensitive drum 363b.

Next, the writing units 363 cause the respective primary transfer rollers 363f to primarily transfer the images formed on the respective photosensitive drums 363b onto the intermediate transfer belt 364 in a sequentially superimposed manner. Thus, an image of the four colors (color toner image) is formed on the intermediate transfer belt 364. Next, each of the writing units 363 causes the cleaning section 363e to remove the toner remaining on the photosensitive drum 363b.

Next, the image forming section 36 causes the sheet feed device 20 or the sheet feed section 361 to feed a sheet P at a time when the image on the rotating intermediate transfer belt 364 reaches the position of the transfer section 365. Next, the image forming section 36 causes the transfer section 365 to secondarily transfer the image (color toner image) from the intermediate transfer belt 364 onto the sheet P. Next, the image forming section 36 conveys the sheet to the fixing section 366 and causes the fixing section 366 to perform fixing processing. In the fixing processing, the fixing section 366 heats and pressurizes the sheet to fix the image onto the sheet. When forming images on both sides of the sheet, the image forming section 36 conveys the sheet to a reversing path R1 to reverse the sheet and then conveys the sheet again to the position of the transfer section 365.

The image reading device 40 is disposed downstream of the image forming apparatus 30. The image reading device 40 includes a reading controller (hardware processor) 41, a reading section (or image reader) 42, and a page memory 43.

The reading controller 41 may include a CPU, a ROM, and a RAM, performs various kinds of processing on analog image data input from the reading section 42, and then generates RGB digital image data. The various kinds of processing include, for example, analog processing, A/D conversion processing, shading correction processing, color conversion processing, scaling processing, and the like. The generated image data is output to the page memory 43.

The reading controller 41 controls reading by the reading section 42. That is, the reading controller 41 functions as a controller of the present invention. For example, the reading controller 41 acquires shading data used for shading correction for the reading section 42 based on a reading result of light reflected by a white reference plate 421d and read by a CCD 421c.

The reading controller 41 compares a correct image for inspection with scan data read by the reading section 42 to inspect the image. This makes it possible to detect attachment of dirt and misprinting.

Furthermore, the reading controller 41 instructs the image forming apparatus 30 to perform color correction based on the scan data read by the reading section 42. In this case, the scan data is image data of a patch image for image quality adjustment read by the reading section 42.

As described above, the reading controller 41 inspects the image based on the scan data read by the reading section 42 and instructs the image forming apparatus 30 to perform color correction. That is, the reading controller 41 functions as an inspection section of the present invention.

The reading section 42 includes a first reading section (or first reader) 421 and a second reading section (or second reader) 422.

The first reading section 421 reads the front surface of a printed material (sheet P) on which an image has been formed by the image forming apparatus 30. The first reading section 421 includes a light source 421a, an optical system 421b, a CCD 421c, and a white reference plate 421d.

The light source 421a includes a light emitting diode (LED), a halogen lamp, or the like, and emits light onto the sheet P conveyed to the reading position.

The optical system 421b forms an image of the light emitted from the light source 421a and reflected by the sheet P (image at the reading position) onto the CCD 421c.

The CCD 421c reads the image formed on the sheet P at a predetermined reading position. Specifically, the CCD 421c reads the light reflected by the sheet P. The CCD 421c includes a color line sensor capable of reading the entire width of the sheet in the width direction.

The white reference plate 421d is disposed at the reading position and reflects the light emitted from the light source 421a. The light reflected by the white reference plate 421d is read by the CCD 421c. The light reflected by the white reference plate 421d is read by the CCD 421c when a sheet is not passed (for example, between sheets).

The second reading section 422 reads the back surface of the printed material (sheet P) on which an image has been formed by the image forming apparatus 30. The second reading section 422 is disposed downstream of the first reading section 421 in the conveyance direction of the sheet P. The second reading section 422 includes a light source 422a, an optical system 422b, a CCD 422c, and a white reference plate 422d. Since the configuration of the second reading section 422 is the same as that of the first reading section 421, the description thereof will be omitted.

As described above, the reading section 42 includes the first reading section 421 that reads the front surface of the sheet P and the second reading section 422 that reads the back surface of the sheet P. Thus, the reading section 42 can read both sides of the sheet P in a single pass. The reading results (analog image data) read by the first reading section 421 and the second reading section 422 are output to the reading controller 41.

The page memory 43 includes, for example, a DRAM and stores the image data generated by the reading controller 41.

The sheet ejection device 50 is disposed downstream of the image reading device 40, and ejects the sheet P, for which the image thereon has been read by the image reading device 40, to the sheet ejection tray 51.

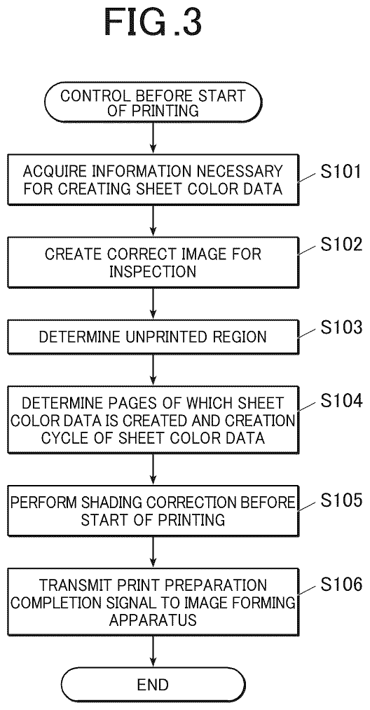

Next, the control of the image inspection system 1 according to the present embodiment will be described with reference to flowcharts in FIGS. 3, 6, 7, and 10.

FIG. 3 is a flowchart illustrating the control before the start of printing. The control before the start of printing is started when the reading controller 41 of the image reading device 40 receives a request to start printing from the print controller 10 or the image forming apparatus 30.

First, the reading controller 41 acquires information necessary for generating sheet color data (step S101). Specifically, the reading controller 41 receives and acquires print data from the print controller 10. Further, the reading controller 41 receives and acquires additional information from the image forming apparatus 30. The additional information includes patch information and trim mark information that are added to a region other than a user printing region within an image of a page of the sheet by the image forming apparatus 30. Further, the reading controller 41 receives and acquires setting information from the image forming apparatus 30. The setting information includes tray setting information and sheet setting information. The tray setting information includes information about a tray to be used for printing. The sheet setting information includes sheet data (sheet type and the like) set for each tray.

Next, the reading controller 41 creates a correct image for inspection (step S102). The correct image is created based on the print data and the additional information acquired in step S101.

Next, the reading controller 41 identifies an unprinted region (blank portion) within the image of the page based on the correct image created in step S102 (step S103).

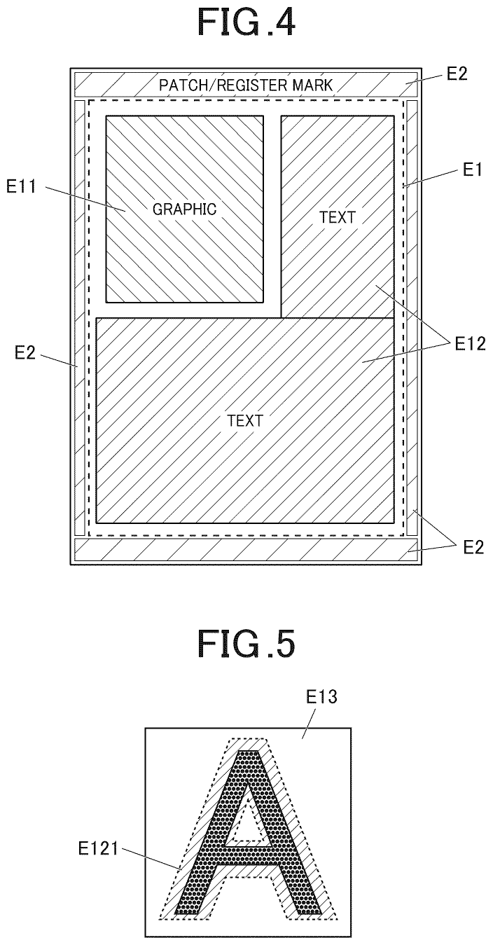

FIG. 4 is a diagram illustrating a method for simply identifying and extracting an unprinted region from the correct image.

A region within a broken line box in FIG. 4 is a user printing region E1. The user printing region E1 is a region where the print data acquired in step S101 is printed. The user printing region E1 includes a graphic region E11 where graphic data is printed and a text region E12 where text data is printed. In the user printing region E1, a region that is neither the graphic region E11 nor the text region E12 is identified as an unprinted region E13.

The region outside (other than) the user printing region E1 is a patch/trim mark addition region E2. In the patch/trim mark addition region E2, a patch for color correction and/or a trim mark for position correction is added.

In the example illustrated in FIG. 4, the text region E12 is simply shown by a square region. The simple text region E12 includes blank portions such as spaces between lines and spaces between characters. FIG. 5 is an enlarged view of a vicinity of a character “A” printed in the simple text region E12. Specifically, as illustrated in FIG. 5, an actual text region E121 is a region bordered by the outline of the character “A”. In the simple text region E12, a region that is not the actual text region E121 (line spacing or character spacing) is identified as the unprinted region E13. That is, the simple text region E12 includes the actual text region E121 and the unprinted region E13. In step S103, the unprinted region E13 included in the simple text region E12 is also identified as an unprinted region.

Next, the reading controller 41 identifies pages on which the sheet color data is to be created and a creation cycle of the sheet color data based on the setting information acquired in step S101 and the unprinted region identified in step S103 (step S104).

When a printing rate of the printed material is high, a sufficient size (data amount) of image data of an unprinted region may not be obtained in a single page. The sufficient data amount is, for example, 128 pixels worth of data for each pixel in a main scanning direction. Therefore, upon detecting that the data amount of the image data of the unprinted region(s) is less than a predetermined value, the reading controller 41 creates the sheet color data based on the image data of the unprinted regions for pages by which the data amount is greater than or equal to the predetermined value. For example, upon detecting that the data amount of the image data of the unprinted region for a single page is less than the predetermined value and the data amount of the image data of the unprinted regions for three pages is greater than or equal to the predetermined value, the sheet color data is created based on the image data of the unprinted regions for the three pages. That is, the reading controller 41 can identify the creation cycle of the sheet color data based on the unprinted region identified in step S103.

The sheet color data needs to be created for sheets of the same type (the same sheet type). Therefore, the reading controller 41 creates the sheet color data based on the image data of the unprinted region of a sheet of the same type. In the case of a MIX job in which sheets of different sheet types are mixed, pages used to create the sheet color data are limited based on information that can identify that sheets of the pages are of the same type. The information that can identify that sheets of the pages are of the same type includes, for example, the setting information (tray setting information or sheet setting information) acquired in step S101. That is, the reading controller 41 can identify the pages on which the sheet color data is to be created based on the setting information acquired in step S101.

Next, the reading controller 41 performs shading correction before the start of printing (step S105). Specifically, at the time of activation or before printing is started by the image forming apparatus 30, the reading controller 41 performs shading correction on the reading section 42 based on shading data. The shading data is acquired by causing the reading section 42 to read the white reference plate 421d disposed opposite the reading section 42.

Next, the reading controller 41 transmits a print preparation completion signal to the image forming apparatus 30 (step S106). Printing is then started by the image forming apparatus 30.

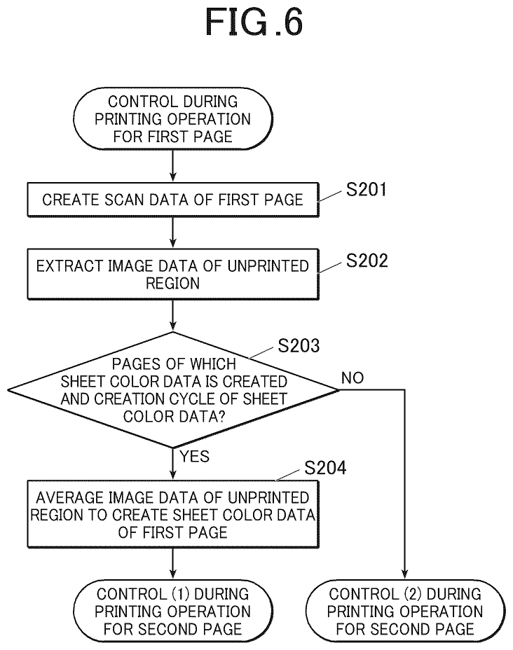

FIGS. 6, 7, and 10 are flowcharts illustrating the control during the printing operation. The control during the printing operation is initiated when the printing is started by the image forming apparatus 30.

FIG. 6 is a flowchart illustrating the control during the printing operation for a first page.

First, the reading controller 41 causes the reading section 42 to read the first page of the printed material to create scan data of the first page (step S201).

Next, the reading controller 41 extracts image data of the unprinted region identified in step S103 from the scan data created in step S201 (step S202).

Next, the reading controller 41 identifies whether the first page corresponds to one of the pages on which the sheet color data is to be created, which are identified in step S104, and whether a current cycle corresponds to the creation cycle of the sheet color data, which is identified in step S104 (step S203).

If the reading controller 41 identifies that the first page corresponds to one of the pages on which the sheet color data is to be created and that the current cycle corresponds to the creation cycle of the sheet color data (YES in step S203), the reading controller 41 advances the process to the next step S204.

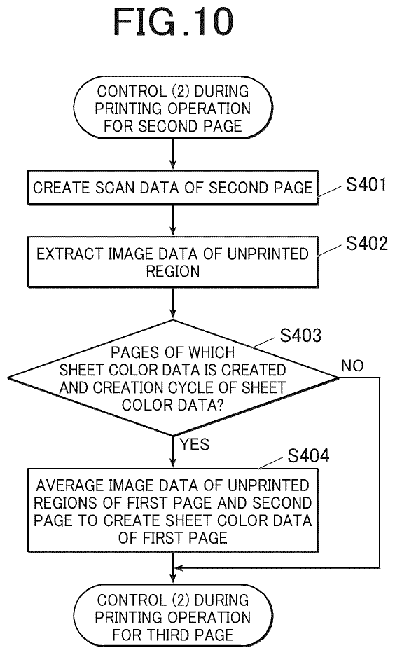

On the other hand, if the reading controller 41 identifies that the first page does not correspond to any of the pages on which the sheet color data is to be created and that the current cycle does not correspond to the creation cycle of the sheet color data cycle (NO in step S203), the reading controller 41 ends the control of the first page. Thereafter, the reading controller 41 proceeds to the control (2) during the printing operation for a second page (see FIG. 10).

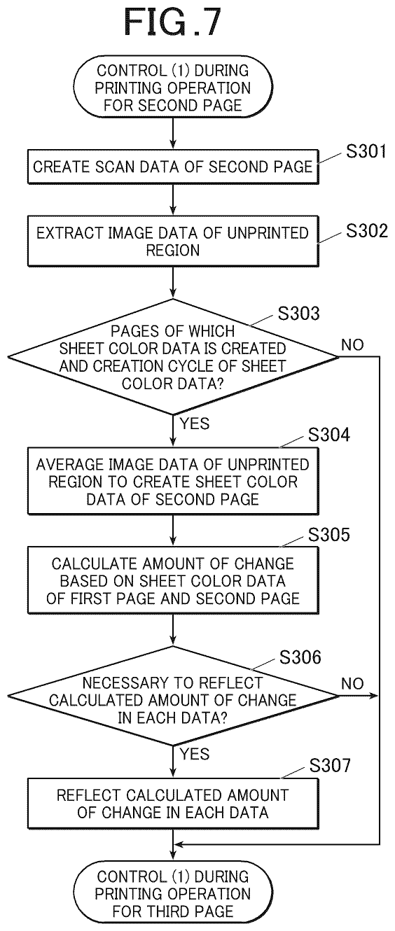

In step S204, the reading controller 41 averages the image data of the unprinted region extracted in step S202 to create the sheet color data of the first page. Specifically, the reading controller 41 creates the sheet color data of the first page by averaging the image data of the unprinted region in the sub-scanning direction. The created sheet color data is one dimensional data in the main scanning direction. Thereafter, the reading controller 41 proceeds to the control (1) during the printing operation for the second page (see FIG. 7).

FIGS. 7 and 10 are flowcharts illustrating the control during the printing operation for the second page. FIG. 7 illustrates the control when step S204 is performed, which is the control (1) during the printing operation for the second page. FIG. 10 illustrates the control when step S204 is not performed, which is the control (2) during the printing operation for the second page.

First, the control in FIG. 7 will be described.

First, the reading controller 41 causes the reading section 42 to read the second page of the printed material to create scan data of the second page (step S301).

Next, the reading controller 41 extracts image data of the unprinted region identified in step S103 from the scan data created in step S301 (step S302).

Next, the reading controller 41 identifies whether the second page corresponds to one of the pages on which the sheet color data is to be created, which are identified in step S104, and whether a current cycle corresponds to the creation cycle of the sheet color data, which is identified in step S104 (step S303).

If the reading controller 41 identifies that the second page corresponds to one of the pages on which the sheet color data is to be created and that the current cycle corresponds to the creation cycle of the sheet color data (YES in step S303), the reading controller 41 advances the process to the next step S304.

On the other hand, if the reading controller 41 identifies that the second page does not correspond to any of the pages on which the sheet color data is to be created and that the current cycle does not correspond to the creation cycle of the sheet color data cycle (NO in step S303), the reading controller 41 ends the control of the second page. Thereafter, the reading controller 41 proceeds to the control (1) during the printing operation for a third page. Since the control (1) during the printing operation for the third and subsequent pages is the same as the control in FIG. 7, the control in FIG. 7 is repeated.

In step S304, the reading controller 41 averages the image data of the unprinted region extracted in step S302 to create the sheet color data of the second page. Thereafter, the reading controller 41 advances the process to the next step S305.

Next, the reading controller 41 calculates the amount of change based on the sheet color data of the first page created in step S204 and the sheet color data of the second page created in step S304 (step S305). The amount of change is an amount of change in the illuminance of the light source 421a (422a), specifically, an amount of change in RGB luminance levels. The amount of change is a ratio indicating a percentage of change for each pixel in the main scanning direction, for example. Note that in the example illustrated in FIG. 7, since the second page has been printed, the sheet color data of the first page and the sheet color data of the second page are compared. For example, in the case of the control (1) during the printing operation for a fifth page, since the fifth page has been printed, the sheet color data of the first page is compared with the sheet color data of the fifth page.

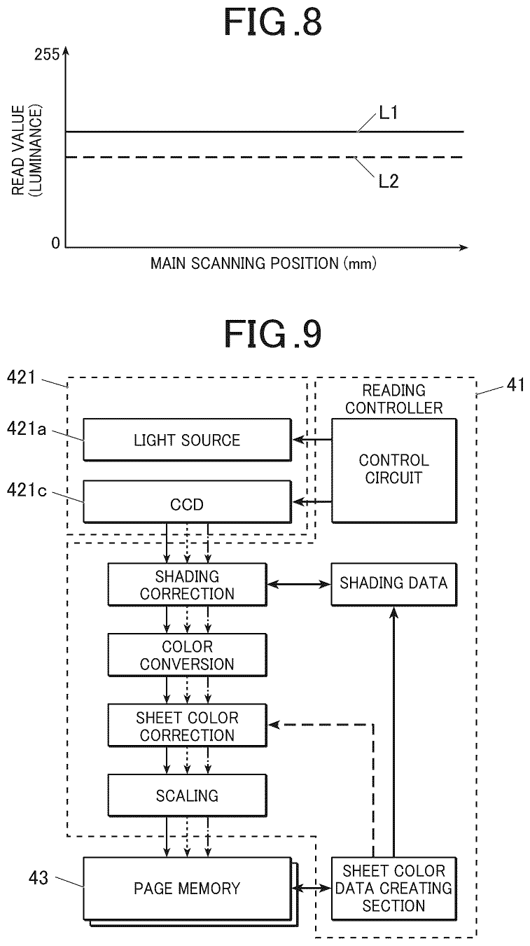

FIG. 8 is a diagram illustrating the sheet color data of the first page and a Nth page. The vertical axis represents the read value (luminance) of the reading section 42. The horizontal axis represents the main scanning position. The symbol L1 in FIG. 8 represents the sheet color data of the first page. The symbol L2 represents the sheet color data of the Nth page.

In step S305, the amount of change in the illuminance is calculated, for example, by dividing the sheet color data L2 of the Nth page by the sheet color data L1 of the first page (e.g., L2/L1 [%]).

Next, the reading controller 41 identifies, based on the amount of change calculated in step S305, whether the calculated amount of change needs to be reflected in each piece of data (step S306). Each piece of data here is the shading data or the scan data. For example, when the amount of change calculated in step S305 is equal to or greater than a predetermined threshold value, the reading controller 41 identifies that the calculated amount of change needs to be reflected in each piece of data. Note that the reading controller 41 may identify that the calculated amount of change needs to be reflected in each piece of data in all cases where the calculated amount of change is not zero, namely, the illuminance has changed.

If the reading controller 41 identifies that the calculated amount of change needs to be reflected in each piece of data (YES in step S306), the reading controller 41 advances the process to the next step S307.

On the other hand, if the reading controller 41 identifies that the calculated amount of change does not need to be reflected in each piece of data (NO in step S306), the reading controller 41 ends the control of the second page. Thereafter, the reading controller 41 proceeds to the control (1) during the printing operation for the third page. Since the control (1) during the printing operation for the third and subsequent pages is the same as the control in FIG. 7, the control in FIG. 7 is repeated.

In step S307, the reading controller 41 reflects the amount of change (difference) calculated in step S305 in each piece of data. That is, the reading controller 41 reflects the difference between the sheet color data immediately after the start of printing and the sheet color data after printing N pages in the shading data or the scan data. The number N is the number of pages printed until the reading controller 41 identifies that the calculated amount of change needs to be reflected in each piece of data. In the example illustrated in FIG. 7, since the second page has been printed, N=2. For example, in the case of the control (1) during the printing operation for the fifth page, since the fifth page has been printed, N=5. Thereafter, the reading controller 41 proceeds to the control (1) during the printing operation for the third page. Since the control (1) during the printing operation for the third and subsequent pages is the same as the control in FIG. 7, the control in FIG. 7 is repeated.

FIG. 9 is a diagram illustrating how the difference in sheet color data is reflected in each piece of data in the reading controller 41. Although only the first reading section 421 is illustrated in FIG. 9 for illustrative purposes, the same control is performed in the second reading section 422.

The reading controller 41 first performs shading correction on scan data read by the CCD 421c. Next, the reading controller 41 performs color conversion processing on the scan data. Next, the reading controller 41 performs scaling processing on the scan data. The scan data subjected to the scaling processing is stored in the page memory.

In the shading correction, the maximum value (white) and the minimum value (black) of the RGB luminance read by the CCD 421c are corrected to the maximum value and the minimum value of the resolution, respectively. The maximum value and the minimum value of the resolution are 255 and 0 for 8-bit gradation, respectively. In general, the maximum value of the RGB luminance is a value obtained by reading the white reference plate 422d disposed at the reading position. The minimum value of the RGB luminance is a value obtained by reading black with the light source 421a turned off. The reading controller 41 performs the shading correction at the time of activation or before the start of printing using the maximum value and the minimum value of the RGB luminance as the shading data.

In step S307, the difference between the sheet color data immediately after the start of printing and the sheet color data after printing N pages is reflected in the shading data or the scan data. When the difference is reflected in the scan data, as illustrated in FIG. 9, the sheet color correction to be reflected in the scan data is performed after the color conversion processing is performed. When the difference is reflected in the shading data, the above sheet color correction is not performed because the correction is reflected in the scan data at the time of the shading correction via the shading data in which the difference has been reflected.

Next, the control in FIG. 10 will be described.

First, the reading controller 41 causes the reading section 42 to read the second page of the printed material to create scan data of the second page (step S401).

Next, the reading controller 41 extracts image data of the unprinted region identified in step S103 from the scan data created in step S401 (step S402).

Next, the reading controller 41 identifies whether the second page corresponds to one of the pages on which the sheet color data is to be created and whether a current cycle correspond to the creation cycle of the sheet color data identified in step S104 (step S403).

If the reading controller 41 identifies that the second page corresponds to one of the pages on which the sheet color data is to be created and that the current cycle corresponds to the creation cycle of the sheet color data (YES in step S403), the reading controller 41 advances the process to the next step S404.

On the other hand, if the reading controller 41 identifies that the second page does not correspond to any of the pages on which the sheet color data is to be created and that the current cycle does not correspond to the creation cycle of the sheet color data cycle (NO in step S403), the reading controller 41 ends the control of the second page. Thereafter, the reading controller 41 proceeds to the control (2) during the printing operation for the third page. Since the control (2) during the printing operation for the third and subsequent pages is the same as the control in FIG. 10, the control in FIG. 10 is repeated.

In step S404, the reading controller 41 averages the image data of the unprinted regions extracted in step S202 and step S402 to create the sheet color data of the first page. That is, the reading controller 41 averages the image data of the unprinted regions of the first page and the second page to create the sheet color data of the first page. Thereafter, the reading controller 41 proceeds to the control (2) during the printing operation for the third page. Since the control (2) during the printing operation for the third and subsequent pages is the same as the control in FIG. 10, the control in FIG. 10 is repeated.

As described above, during the reading operation on a printed material by the reading section 42, the reading controller 41 first extracts image data of an unprinted region (blank portion) of the printed material based on scan data read by the reading section 42. Next, the reading controller 41 creates sheet color data for the reading section 42 based on the extracted image data of the unprinted region.

The reading controller 41 performs the shading correction on the first reading section 421 based on shading data acquired by causing the first reading section 421 to read the white reference plate 421d disposed opposite the first reading section 421.

The reading controller 41 performs the shading correction on the second reading section 422 based on shading data acquired by causing the second reading section 422 to read the white reference plate 422d disposed opposite the second reading section 422.

During the reading operation on the printed material by the first reading section 421, the reading controller 41 first extracts image data of an unprinted region of the printed material based on scan data read by the first reading section 421. Next, the reading controller 41 creates sheet color data for the first reading section 421 based on the extracted image data of the unprinted region.

During the reading operation on the printed material by the second reading section 422, the reading controller 41 first extracts image data of an unprinted region of the printed material based on scan data read by the second reading section 422. Next, the reading controller 41 creates sheet color data for the second reading section 422 based on the extracted image data of the unprinted region.

As described above, the reading controller 41 performs the shading correction and the creation of the sheet color data independently for each of the first reading section 421 and the second reading section 422.

As described above, the image reading device 40 according to the present embodiment includes the reading section 42 and the controller (reading controller 41). The reading section 42 is disposed downstream of the image forming apparatus 30 and reads the printed material on which an image has been formed by the image forming apparatus 30. The controller controls reading by the reading section 42. The controller performs the shading correction on the reading section 42 at the time of activation or before printing is started by the image forming apparatus 30, based on shading data acquired by causing the reading sections 42 to read the white reference plates 421d and 422d respectively disposed opposite the reading sections 42. During the reading operation on the printed material by the reading section 42, the controller first extracts image data of an unprinted region of the printed material based on scan data read by the reading section 42. Next, the controller creates sheet color data for the reading section 42 based on the extracted image data of the unprinted region.

Therefore, according to the image reading device 40 of the present embodiment, it is possible to obtain a reading result that is not affected by the light amount change without stopping printing. Therefore, it is possible to improve the accuracy of inspection and colorimetry by an image inspection apparatus without causing downtime.

Furthermore, the controller creates the sheet color data by averaging the image data of the unprinted region in the sub-scanning direction. The controller reflects the difference between the sheet color data immediately after the start of printing and the sheet color data after printing N pages in the shading data or the scan data.

Therefore, it is possible to compare the difference in levels between the sheet color data of the first printed page and the sheet color data of the Nth printed page. Thus, illuminance changes of the light sources 421a and 422a can be detected with accuracy. Therefore, it is possible to improve the accuracy of inspection and colorimetry by an image inspection apparatus.

Furthermore, the controller identifies an unprinted region based on a correct image created for inspection and extracts image data of the identified unprinted region.

Therefore, an unprinted region (blank portion) can be detected easily and accurately. Therefore, it is possible to further improve the accuracy of inspection and colorimetry by an image inspection apparatus.

Upon determining that the data amount of the image data of the unprinted region(s) is less than a predetermined value, the controller creates the sheet color data based on the image data of the unprinted regions for pages by which the data amount is greater than or equal to the predetermined value.

This allows a sufficient amount of image data to be obtained even when the sufficient amount of image data cannot be obtained in a single page. Therefore, the sheet color data can be created more reliably.

The controller creates sheet color data based on image data of an unprinted region of a sheet of the same type.

Therefore, even in the case of a MIX job in which sheets of different sheet types are mixed, the sheet color data can be created. Therefore, it is possible to more reliably improve the accuracy of inspection and colorimetry by an image inspection apparatus.

The reading section 42 includes the first reading section 421 that reads the front surface of the printed material and the second reading section 422 that reads the back surface of the printed material. The controller performs the shading correction on the first reading section 421 based on shading data acquired by causing the first reading section 421 to read the white reference plate 421d disposed opposite the first reading section 421. The controller performs the shading correction on the second reading section 422 based on shading data acquired by causing the second reading section 422 to read the white reference plate 422d disposed opposite the second reading section 422. During the reading operation on the printed material by the first reading section 421, the controller first extracts image data of an unprinted region of the printed material based on scan data read by the first reading section 421. Next, the controller creates sheet color data for the first reading section 421 based on the extracted image data of the unprinted region. During the reading operation on the printed material by the second reading section 422, the controller first extracts image data of an unprinted region of the printed material based on scan data read by the second reading section 422. Next, the controller creates sheet color data for the second reading section 422 based on the extracted image data of the unprinted region.

Thus, even when a sheet-fed machine capable of performing double-sided printing includes a plurality of reading sections 42, each of the reading sections 42 can be independently controlled. Therefore, even for a sheet-fed machine capable of performing double-sided printing, it is possible to improve the accuracy of inspection and colorimetry by an image inspection apparatus.

Although the present invention has been described in detail based on the embodiment, the present invention is not limited to the above-described embodiment. The embodiment can be modified without departing from the spirit and scope of the invention.

For example, in the above-described embodiment, a configuration in which the reading controller 41 functions as the inspection section of the present invention has been described as an example, but the present invention is not limited thereto. For example, the controller 31 of the image forming apparatus 30 may function as the inspection section of the present invention. Furthermore, a controller (not illustrated) of the external device 2 may function as the inspection section of the present invention.

Furthermore, although the above-described embodiment illustrates a configuration in which the present invention is applied to a sheet-fed machine capable of performing double-sided printing on a sheet, the present invention is not limited thereto. For example, the present invention may be applied to a roll machine that forms an image on continuous paper such as a roll sheet. In this case, since printing is performed only on the front surface of the sheet (continuous paper), the reading section 42 needs to be provided only on a side facing the front surface of the sheet (first reading section 421).

Furthermore, in the above-described embodiment, a configuration in which the electrophotographic method is applied for the image forming section 36 has been described as an example, but it is not limited thereto. For example, instead of the electrophotographic method, another printing method such as an inkjet method or a thermal sublimation method may be applied.

The detailed configuration and the detailed operation of each component constituting the image inspection system can be appropriately changed without departing from the scope of the present invention. Although embodiments of the present invention have been described and shown in detail, the disclosed embodiments are made for purposes of illustration and example only and not limitation. The scope of the present invention should be interpreted by terms of the appended claims.

The entire disclosure of Japanese Patent Application No. 2024-110208 filed on Jul. 9, 2024, is incorporated herein by reference in its entirety.

What is claimed is:

1. An image reading device comprising:
an image reader that is disposed downstream of an image forming apparatus and performs reading of a printed material, the printed material being a sheet on which an image has been formed by the image forming apparatus; and
a hardware processor that controls the reading performed by the image reader, wherein
the hardware processor:
performs shading correction on the image reader at a time of activation of the image reading device or before printing is started by the image forming apparatus, based on shading data acquired by causing the image reader to read a white reference plate disposed opposite the image reader;
extracts image data of an unprinted region of the printed material during the reading of the printed material performed by the image reader, based on scan data of the printed material read by the image reader; and
creates sheet color data for the image reader based on the image data of the unprinted region that has been extracted.

2. The image reading device according to claim 1, wherein
the hardware processor further:
creates the sheet color data by averaging the image data of the unprinted region in a sub-scanning direction, and
reflects in the shading data a difference between the sheet color data immediately after the printing is started by the image forming apparatus and the sheet color data after N pages are printed by the image forming apparatus.

3. The image reading device according to claim 1, wherein
the hardware processor further:
creates the sheet color data by averaging the image data of the unprinted region in a sub-scanning direction, and
reflects in the scan data a difference between the sheet color data immediately after the printing is started by the image forming apparatus and the sheet color data after N pages are printed by the image forming apparatus.

4. The image reading device according to claim 1, wherein
the hardware processor further:
identifies the unprinted region based on a correct image created for inspection, and
extracts the image data of the unprinted region that has been identified.

5. The image reading device according to claim 1, wherein
upon detecting that a data amount of the image data of the unprinted region is less than a predetermined value, the hardware processor creates the sheet color data based on the image data of the unprinted region for multiple pages of the printed material by which a sum of the data amount is greater than or equal to the predetermined value.

6. The image reading device according to claim 1, wherein
the hardware processor creates the sheet color data based on the image data of the unprinted region of the sheet of a same type.

7. The image reading device according to claim 1, wherein
the image reader includes:
a first reader that performs reading of a front surface of the printed material; and
a second reader that performs reading of a back surface of the printed material, and
the hardware processor:
performs the shading correction on the first reader based on shading data acquired by causing the first reader to read a white reference plate disposed opposite the first reader;
performs the shading correction on the second reader based on shading data acquired by causing the second reader to read a white reference plate disposed opposite the second reader;
extracts image data of an unprinted region of the front surface during the reading of the front surface performed by the first reader, based on scan data of the front surface read by the first reader;
creates the sheet color data for the first reader based on the image data of the unprinted region of the front surface that has been extracted;
extracts image data of an unprinted region of the back surface during the reading of the back surface performed by the second reader, based on scan data of the back surface read by the second reader; and
creates the sheet color data for the second reader based on the image data of the unprinted region of the back surface that has been extracted.

8. An image inspection system comprising:
an image reader that is disposed downstream of an image forming apparatus and performs reading of a printed material, the printed material being a sheet on which an image has been formed by the image forming apparatus; and
a hardware processor that:
controls the reading performed by the image reader;
inspects the image based on scan data of the printed material read by the image reader; and
instructs the image forming apparatus to perform color correction based on the scan data, wherein
the hardware processor:
performs shading correction on the image reader at a time of activation of the image inspection system or before printing is started by the image forming apparatus, based on shading data acquired by causing the image reader to read a white reference plate disposed opposite the image reader;
extracts image data of an unprinted region of the printed material during the reading of the printed material performed by the image reader, based on the scan data; and
creates sheet color data for the image reader based on the image data of the unprinted region that has been extracted.

9. A non-transitory computer-readable recording medium storing a program executable by a computer, the program causing a computer of an image reading device including an image reader that is disposed downstream of an image forming apparatus and performs reading of a printed material, the printed material being a sheet on which an image has been formed by the image forming apparatus, to execute:
controlling the reading performed by the image reader;
performing shading correction on the image reader at a time of activation of the image reading device or before printing is started by the image forming apparatus, based on shading data acquired by causing the image reader to read a white reference plate disposed opposite the image reader;
extracting image data of an unprinted region of the printed material during the reading of the printed material performed by the image reader, based on scan data of the printed material read by the image reader; and
creating sheet color data for the image reader based on the image data of the unprinted region that has been extracted.
